(19) United States
(12) Patent Application Publication
(10) Pub. No.: US 2007/0275682 A1
(43) Pub. Date: Nov. 29, 2007

(54) DIGITAL BROADCAST RECEPTION APPARATUS AND RECEPTION METHOD

(75) Inventor: Naoto Adachi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/554,752

(22) Filed: Oct. 31, 2006

(30) Foreign Application Priority Data
May 25, 2006 (JP) 2006-145706

(51) Int. Cl. H04B 1/18

(52) U.S. Cl. 455/185.1

(57) ABSTRACT

A reception apparatus comprises a counter for counting a passage of a predetermined time in a standby mode other than a regular reception mode in which all circuits constituting the reception apparatus operate; and an emergency broadcast state detection unit for judging whether or not a digital broadcast is in a state of broadcasting an emergency broadcast at every passage of the predetermined time counted by the counter.

### CROSS-REFERENCE TO RELATED APPLICATION

This application is based upon and claiming the benefit of priority from the prior Japanese Patent Application No. 2006-145706 filed in May 25, 2006, the entire contents of which are incorporated herein by reference.

### BACKGROUND OF THE INVENTION

1. Field of the Invention

The present invention relates to a reception apparatus and a reception method for use in a terrestrial digital broadcasting using a transmission system called an Orthogonal Frequency Division Multiplexing (OFDM) system.

2. Description of the Related Art

Proposed in a recent year as a system for transmitting a digital signal is called an Orthogonal Frequency Division Multiplexing (OFDM) system. The OFDM system is one for transmitting data by allocating it to a plurality of carriers which are perpendicular on/relative to a frequency axis in which the modulation and demodulation are carried out by an inverse fast Fourier transform (IFFT) and a fast Fourier transform (FFT), respectively. Taking advantage of high efficiency of frequency utilization, the OFDM system is widely considered as an application to the terrestrial digital broadcasting. The standard for the terrestrial digital broadcasting of Japan, i.e., Integrated Services Digital Broadcasting-Terrestrial (ISDB-T), also uses the system.

FIG. 1 shows a configuration of a common OFDM system. A signal received by an antenna is input to a tuner 100 which selects a channel to receive, converts the signal to an Intermediate Frequency (IF) signal and outputs it. The output of the tuner 100 is input to an analog-to-digital (A/D) conversion unit 101 and is converted from an analog signal into a digital signal thereby. The output of the A/D conversion unit 101 is input to an orthogonal demodulation unit 102 and is converted into a complex baseband signal. The complex baseband signal is converted from a time zone signal into a frequency zone signal by an FFT applied by an FFT unit 103, thereby obtaining each piece of carrier data.

Each piece of carrier data includes, in addition to a carrier used for transmitting data, a Scattered Pilot (SP) used for a synchronous detection, an Auxiliary Channel (AC) carrier used for a transmission of auxiliary information and a Transmission and Multiplexing Configuration Control (TMCC) carrier for transmitting transmission parameter information, et cetera.

Among the aforementioned, the AC and TMCC carriers are demodulated by a Differential Binary Phase Shift Keying (DBPSK), then TMCC information such as transmission parameter information is extracted from the result of the demodulation by a TMCC extraction unit 106, then the result is given to a TMCC error correction unit 107, and an error correction process for the TMCC is performed.

The other output of the FFT unit 103 is input to an equalization process unit 104, is subjected to an equalization process for a data carrier from a frequency response of the transmission path, and is output as demodulated data. The demodulated data output from the equalization process unit 104 is output to an error correction unit 105 and is subjected to an error correction process, followed by being output as a format called a Transform Stream (TS).

According to a patent document 1 as a conventional technique relating to a reception/demodulation system for use in a terrestrial digital broadcasting, a digital broadcasting demodulation apparatus 1000 comprises a signal process unit 8, an RS code decoding unit 9 and a TS selection unit 10 which are for performing a signal process corresponding to a screen image voice output among a signal demodulated by a tuner 1, a PSK demodulation unit 6 and a Viterbi decoding unit 7, et cetera; a TMCC signal process unit 12 for performing a process for a TMCC signal; and an RS decoding unit 13. A CPU 4 receives a TMCC signal separated by the TMCC signal process unit 12 by way of a CPU interface (I/F) 15 and establishes the operation mode of the signal process unit 8, RS code decoding unit 9 and TS selection unit 10 as a power save operation mode by controlling a power save control unit 16 if an emergency broadcasting is not received. This configuration provides a low power consumption digital broadcasting demodulation apparatus comprising a demodulation and a signal process functions for the reception of a broadcasting satellite (BS) digital broadcasting, et cetera.

Likewise, according to a patent document 2 as a conventional technique, a power save mode controller 120 demodulates a phase reference burst signal and a TMCC including a flag for identifying a wakeup broadcast at the time of a power save mode, while stops a demodulation operation for at least a part of other signals. In the event of stopping the demodulation operation, the operations of an AGC circuit 117, a carrier reproduction circuit 113, a symbol reproduction circuit 112 and a waveform equalizer 110 for example are stopped, thereby saving the power. This configuration solves such problems as an occurrence of a time lag and a failure of a reception as a result of being unable to receive a wakeup broadcast, such as an emergency broadcast, at once.

Likewise, according to a patent document 3 as a similar conventional technique, a warning unit 12 makes an LED 22 emit light for a predetermined time period when a reception unit 11 receives an emergency warning flag signal, followed by giving a warning end signal to a control unit 13. The control unit 13 operates the reception unit 11 and drive circuit 23 intermittently so that the reception unit 11 and drive circuit 23 repeat an operation state for a predetermined time period during the time when the reception unit receives no emergency warning flag signal and a rest state for a predetermined time period following the operation state. Then, when the reception unit 11 receives an emergency warning flag signal, the control unit 13 puts the reception unit 11 and drive circuit 23 in an operation state until a warning end signal is given by the drive circuit 23, and when a warning end signal is given, the control unit 13 operates the reception unit 11 and drive circuit 23 intermittently again. This configuration makes it possible to receive an emergency signal within a digital broadcast signal and provide a reception apparatus enabling a battery drive at a low consumption power.

In a terrestrial digital broadcasting, a flag for notifying of an emergency broadcast is allocated in a TMCC signal which is used for transmitting information such as a transmission parameter.

Since the emergency broadcast aims at notifying of information at a disaster occurrence, et cetera, it is necessary to receive it at once. In the case of receiving a terrestrial digital broadcasting by a mobile terminal such as a portable phone, the power consumption is important. In order to receive an emergency broadcast at once, the only available method is to confirm a presence or absence thereof by receiving an emergency broadcast flag allocated to TMCC data, and therefore it is necessary to decode a TMCC at all times, thus facing a problem of a consumption power becoming high.

A conventional technique according to the above noted patent document 3 also makes it possible to reduce power consumption; the technique, however, can receive only an emergency broadcast and unable to detect a presence or absence of an emergency broadcast at the time of a standby.

[Patent document 1] Laid-Open Japanese Patent Application Publication No. 2001-94902

[Patent document 2] Laid-Open Japanese Patent Application Publication No. 2001-218129

[Patent document 3] Laid-Open Japanese Patent Application Publication No. 2006-60458

### SUMMARY OF THE INVENTION

In consideration of the situation as described above, the purpose of the present invention is to monitor only a presence or absence of an emergency broadcast at low power consumption periodically for example, and enable the startup of a normal reception function at once at the time of an emergency broadcast.

According to the present invention, a reception apparatus for receiving a digital broadcast comprises a counter for counting a passage of a predetermined time in a standby mode other than a regular reception mode in which all circuits constituting the reception apparatus operate; and an emergency broadcast state detection unit for judging whether or not a digital broadcast is in a state of broadcasting an emergency broadcast for every passage of the predetermined time counted by the counter. The reception apparatus further comprises an overall control unit for starting an operation of the counter in case of starting the standby mode and starting operations of all circuits constituting the reception apparatus in case of starting the regular reception mode.

### BRIEF DESCRIPTION OF THE DRAWINGS

FIG. 1 is a block diagram showing a comprisal of a conventional example of a digital broadcast reception apparatus;

FIG. 2 is a block diagram showing the fundamental comprisal of a digital broadcast reception apparatus according to the present invention;

FIG. 3 is a description diagram of a basis of a digital broadcast reception method according to the present invention;

FIG. 4 is a block diagram of a detail comprisal of a digital broadcast reception apparatus according to the present embodiment;

FIG. 5 is a description diagram exemplifying a data format of a control information transmission carrier (TMCC);

FIG. 6 is a description diagram of a value of each item of data shown in FIG. 5; and

FIG. 7 is a detail flow chart of processes at an overall control unit.

### DESCRIPTION OF THE PREFERRED EMBODIMENTS

The following is a detailed description of the preferred embodiment of the present invention by referring to the accompanying drawings.

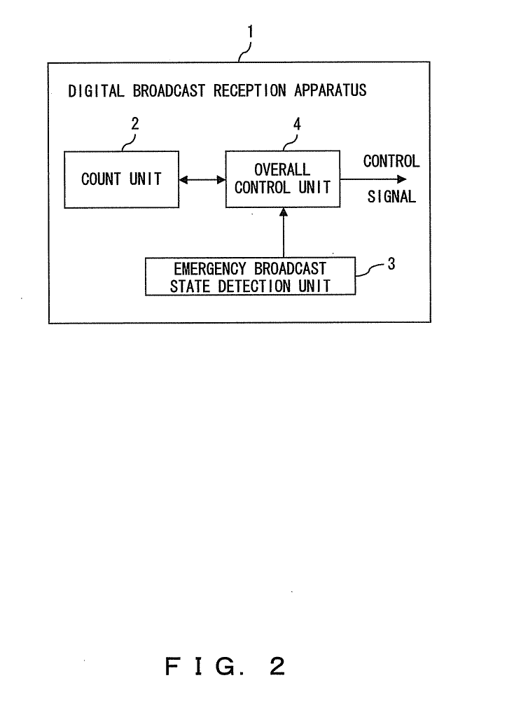

FIG. 2 is a block diagram showing the fundamental comprisal of a digital broadcast reception apparatus according to the present invention. Referring to FIG. 2, the digital broadcast reception apparatus 1 comprises at least a count unit 2 and an emergency broadcast detection unit 3.

The count unit 2 is disposed for counting a passage of a predetermined time in a standby mode other than a regular reception mode in which all circuits constituting the digital broadcast reception apparatus 1 operate, and the emergency broadcast state detection unit 3 is disposed for judging whether or not a digital broadcast is in a state of broadcasting an emergency broadcast at every passage of the predetermined time counted by the count unit 2.

According to the preferred embodiment of the invention, the digital broadcast reception apparatus 1 further comprises an overall control unit 4 which is disposed for starting an operation of the count unit 2 in case of starting the standby mode and starting operations of all circuits constituting the digital broadcast reception apparatus 1 in case of starting the regular reception mode.

According to the preferred embodiment, the count unit 2 is disposed for counting a low speed clock which is different from an overall operation clock for controlling the entirety of the digital broadcast reception apparatus 1, and only the count unit 2 operates on the low speed clock in a standby state, whereas the clocks for all other circuit blocks constituting the digital broadcast reception apparatus 1 are stopped, thereby making it possible to monitor a reception of an emergency broadcast while maintaining a consumption power at an extremely low level.

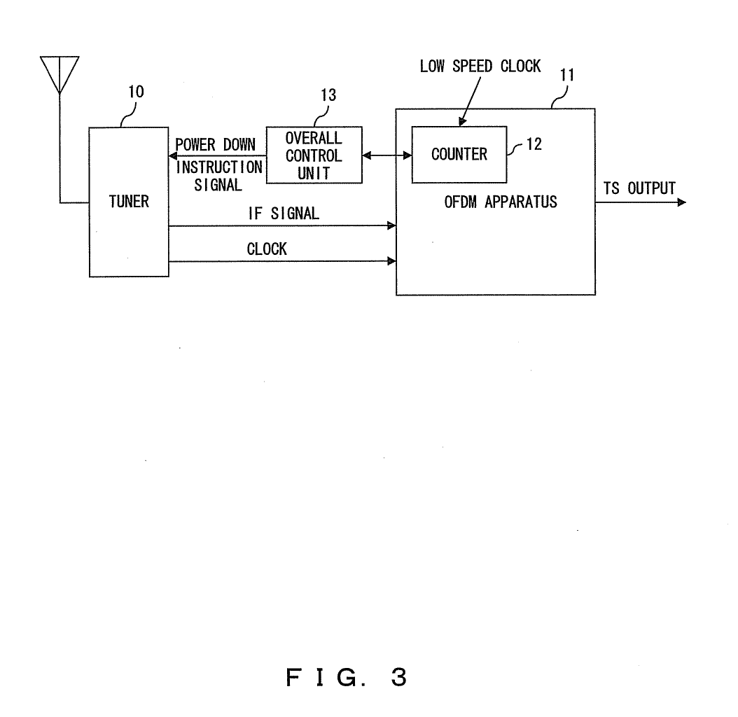

FIG. 3 is a description diagram of a basis of a digital broadcast reception method according to the present invention. The present embodiment is configured to stop supplying a clock to all circuits including a tuner 10, supplies a low speed clock only to a counter 12 from a portable phone for example, read TMCC information at a constant interval under the control of an overall control unit 13 and validate a presence or absence of an emergency broadcast flag in the standby mode other than a regular broadcast reception mode, thereby discerning an emergency broadcast or not at a low consumption power.

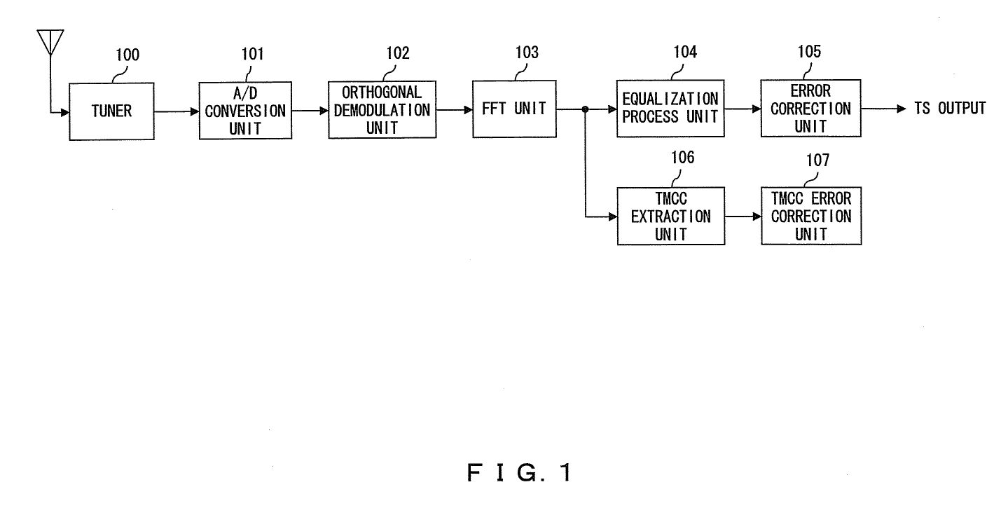

During the operation of the counter 12, the overall control unit 13 issues a power-down instruction to the tuner 10 which accordingly stops the entire operation. Asstopping a supply of a clock provided to an OFDM apparatus 11 over from the tuner 10, resulting in only the counter 12 operating by being solely supplied by another series of clocks within the OFDM apparatus 11, thus becoming an extremely low consumption state. Note that the OFDM apparatus 11 excluding the counter 12 corresponds to all comprisal blocks of the A/D conversion unit 101 and the later stages shown in FIG. 1.

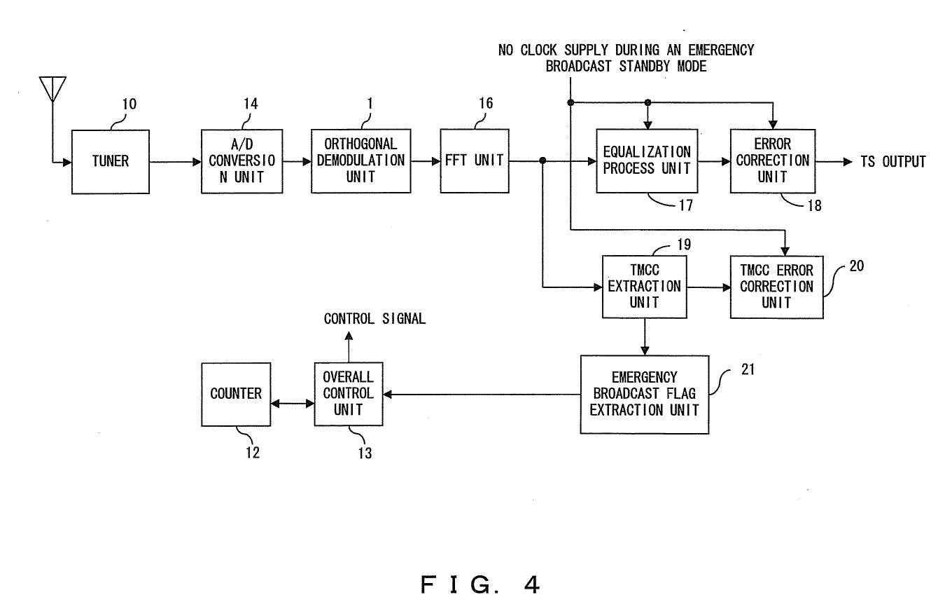

FIG. 4 is a block diagram of a comprisal of a digital reception apparatus. During an operation of the counter 12, the operation is only thereby. Although it is necessary to start up the tuner 10 and OFDM apparatus 11 at the time of detecting an emergency broadcast flag by the counter 12 counting up a predetermined time period, the configuration is in a manner to leave unnecessary circuits for detecting an emergency broadcast flag remain stopped as much as possible, in lieu of starting up all the circuits. An equalization process unit 17 and an error correction unit 18, which are given data of an FFT unit 16, are made to remain stopped by being not supplied with a clock. Furthermore, as for TMCC information, a clock for a TMCC error correction unit 20, which corrects an error by accumulating TMCC data for one frame is also stopped, because only a detection of an emergency broadcast flag is necessary.

Because the present invention aims at a secure reception of a broadcast at the time of an emergency broadcast, only a secure radio wave reception state enabling an error-free TS output constitutes a meaning of the present invention, and therefore an error correction for a TMCC in such a state is unnecessary, and an omittance of the error correction makes it possible to shorten a process time and further reduce a consumption power.

By monitoring a value of an emergency broadcast flag, among the TMCC data output from the FFT unit 16, all circuits are automatically reverted back if it is judged as an emergency broadcast, thus shifting to the regular reception mode. If it is not an emergency broadcast, the clock supply to all the circuits are stopped again for continuing the counting operation of the counter 12. Note that a count unit in claim 1 of the present invention corresponds to the counter 12, an emergency broadcast state detection unit therein corresponds to the emergency broadcast flag extraction unit 21, and an overall control unit in the claim 2 corresponds to the overall control unit 13.

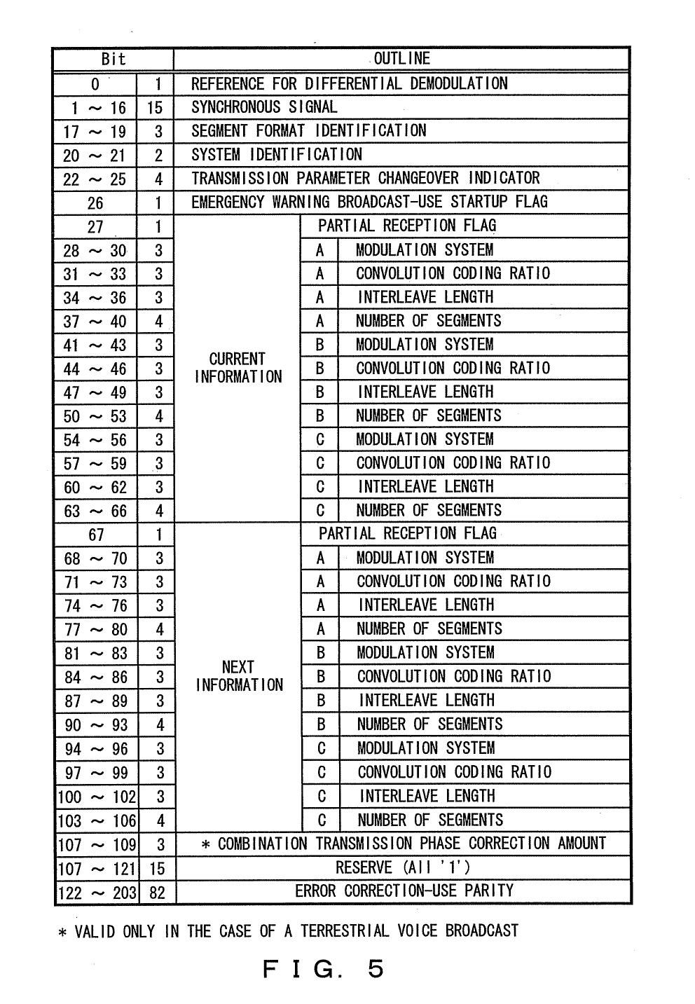

FIG. 5 exemplifies a data format of a control information transmission carrier, that is, a TMCC. Referring to FIG. 5, from bit #0 through bit #203, that is, 204-bit data, constitutes TMCC data by the unit of one frame. Among these pieces of data, a flag used for judging an emergency broadcast, that is, an emergency warning broadcast-use startup flag is stored as one-bit data of 26 bits.

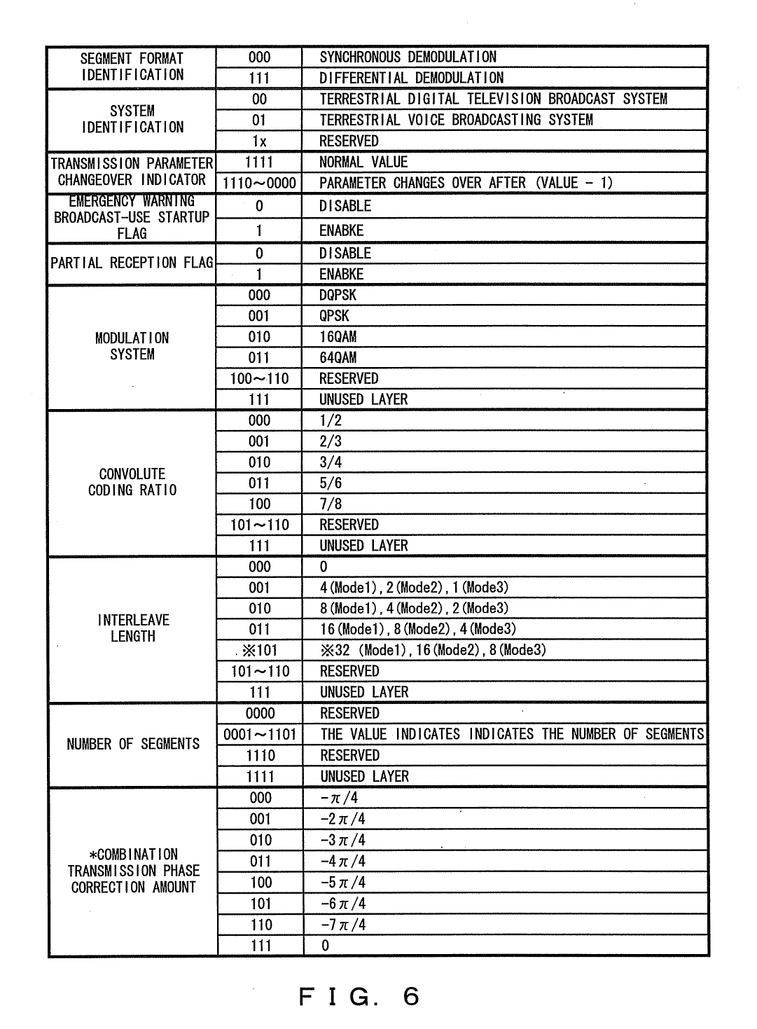

FIG. 6 exemplifies a content of each bit data corresponding to FIG. 5. Referring to FIG. 5 for example, the segment format identification data stored in three bits, that is, from the bit 17 to bit 19, indicates a synchronous demodulation when the three-bit data is “000”, while indicates a differential demodulation when it is “111”. The emergency warning broadcast-use startup flag used in the present invention indicates a disabled, that is, an emergency broadcast is not in progress when the value of the flag is “0” while indicates an enabled, that is, an emergency broadcast is in progress when the value is “1”.

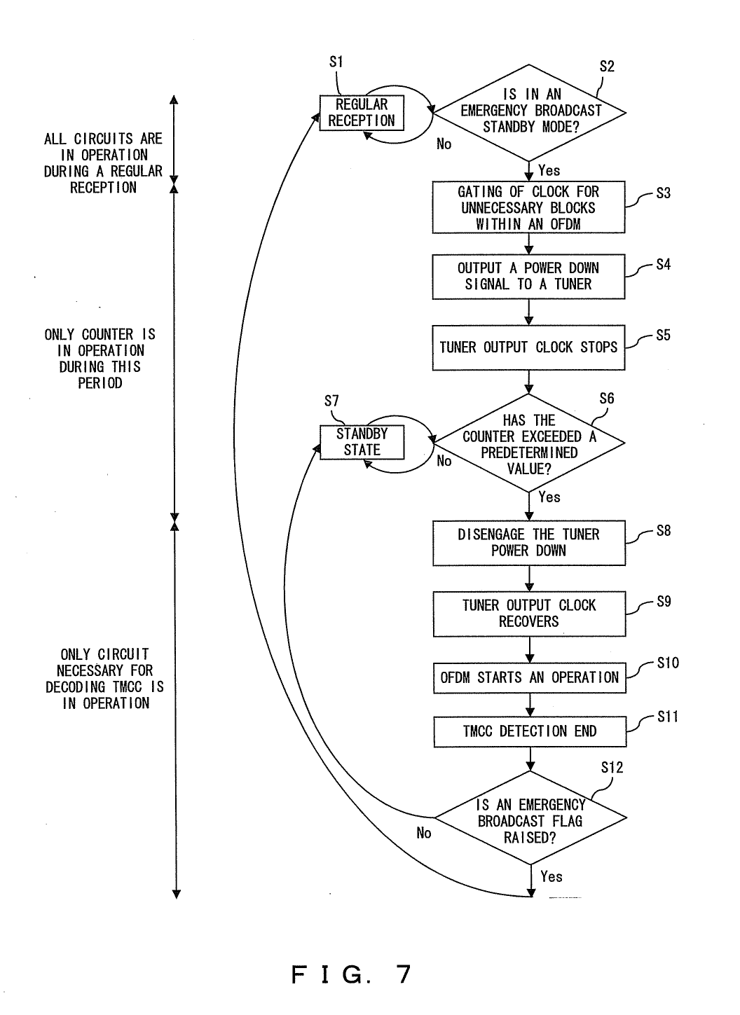

FIG. 7 shows a flow chart of processes at an overall control unit. The step S1 shifts from the regular reception mode to an emergency broadcast standby mode of the step S2, then the step S3 stops a clock supply for the blocks unnecessary for extracting an emergency broadcast flag, such as the equalization process unit 17, error correction unit 18 and TMCC error correction unit 20, and the step S4 issues an istruction to the tuner 10 for a power down. Then the clock supplied to the OFDM apparatus 11 stops in the step S5, thus causing to stop operations, with the exception of the counter 12 which is operated by a separate low speed clock. Since other circuits remain stopped until the counter 12 counts up to a predetermined time period, this makes a state of a minimal consumption power.

If the step S6 judges that the predetermined time period is counted up, the step S8 issues an instruction to the tuner 10 for its recovery, and the step S9 supplies the OFDM apparatus 11 with a clock. The step S10 has the OFDM apparatus 11 start an operation, the step S11 extracts a TMCC, the step S12 examines a presence or absence of an emergency broadcast and, if an emergency broadcast flag is not raised, the step S7 shifts the process to a standby state in which only the counter 12 operates, while, if an emergency broadcast flag is raised, shifts the process to the step S1, i.e., the regular reception mode, by recovering all the circuits.

As such, the present invention is contrived to supply only a counter counting a standby time length with a separate clock and completely stop a supply of a clock to other circuits including a tuner, thereby enabling a periodical examination of a presence or absence of an emergency broadcast in a low consumption power.

What is claimed is:

1. A reception apparatus for receiving a digital broadcast, comprising:
a counter for counting a passage of a predetermined time in a standby mode other than a regular reception mode in which all circuits constituting the reception apparatus operate; and
an emergency broadcast state detection unit for judging whether or not a digital broadcast is in a state of broadcasting an emergency broadcast at every passage of the predetermined time counted by the counter.

2. The reception apparatus for receiving a digital broadcast according to claim 1, further comprising
an overall control unit for starting an operation of said counter in case of starting said standby mode and starting operations of all circuits constituting the reception apparatus in case of starting said regular reception mode.

3. The reception apparatus for receiving a digital broadcast according to claim 2, wherein
said overall control unit makes the digital broadcast reception apparatus start an operation of a regular reception mode when said emergency broadcast state detection unit detects a state of an emergency broadcast.

4. The reception apparatus for receiving a digital broadcast according to claim 1, wherein
said counter counts a low speed clock other than an operation clock of the entirety of the digital broadcast reception apparatus.

5. The reception apparatus for receiving a digital broadcast according to claim 4, wherein
said overall control unit stops an operation clock of the entirety of the digital broadcast reception apparatus at the time of starting said standby mode.

6. The reception apparatus for receiving a digital broadcast according to claim 5, wherein
said overall control unit reduces a power of a tuner within the digital broadcast reception apparatus and stops said operation clock used within the reception apparatus including the tuner at the time of starting said standby mode.

7. The reception apparatus for receiving a digital broadcast according to claim 2, wherein
said emergency broadcast state detection unit detects a state of an emergency broadcast by a value of a flag indicating the state of an emergency broadcast within a control information transmission carrier included in data of said digital broadcast.

8. The reception apparatus for receiving a digital broadcast according to claim 7, wherein
said overall control unit supplies a clock to only a part necessary for judging a value of said emergency broadcast state indication flag within the digital broadcast reception apparatus, and detects an emergency broadcast state by said emergency broadcast state detection unit, at every time when said counter counts up to said predetermined time.

9. The reception apparatus for receiving a digital broadcast according to claim 8, wherein
said overall control unit does not supply a clock to an error correction circuit for said control information transmission carrier even if said counter counts up to said predetermined time.

10. A method for receiving a digital broadcast, comprising:
counting a passage of a predetermined time in a standby mode other than a regular reception mode in which all circuits constituting the reception apparatus operate; and
judging whether or not a digital broadcast is in a state of broadcasting an emergency broadcast at every passage of the predetermined time counted by the counter.
